(19) United States
(12) Patent Application Publication
(10) Pub. No.: US 2026/0302052 A1
(43) Pub. Date: Oct. 1, 2026

(54) COIL COMPONENT

(71) Applicant: TAIYO YUDEN CO., LTD., Tokyo (JP)

(72) Inventors: Yoshimi SHIKANO, Tokyo (JP); Shunpei OTSUKA, Tokyo (JP)

(21) Appl. No.: 19/572,030

(22) Filed: Mar. 19, 2026

(30) Foreign Application Priority Data
Mar. 27, 2025 (JP) 2025-054556

(51) Int. Cl. H01F 27/29

(52) U.S. Cl. CPC H01F 27/292

(57) ABSTRACT

A coil component includes: a base including a magnetic material and provided with an outermost insulator layer on an outermost side in a thickness direction; a coil conductor provided in the base and including a circumferential portion and a lead portion at least partially penetrating through the outermost insulator layer; an external terminal provided on a surface of the outermost insulator layer and connected to the circumferential portion through the lead portion; and a first conductor pattern provided on the surface of the outermost insulator layer opposite to the external terminal and connected to the external terminal through a through hole penetrating through the outermost insulator layer and provided separately from the lead portion.

### CROSS-REFERENCE TO RELATED APPLICATIONS

The present application is based on and claims priority to Japanese Patent Application No. 2025-054556 filed on Mar. 27, 2025, the entire contents of which are hereby incorporated by reference.

### BACKGROUND

### 1. Field of the Invention

The present disclosure relates to a coil component.

### 2. Description of the Related Art

In order to miniaturize a coil component, a structure is known in which an external terminal is provided on one mounting surface of a substrate and not provided on the other surface (e.g., Japanese Laid-Open Patent Application No. 2019-125606). A structure is known in which a groove recessed vertically is provided on the surface of the substrate and a part of the external terminal enters the groove (e.g., International Publication No. WO2009/096243).

### SUMMARY

An embodiment of the present disclosure is a coil component including: a base including a magnetic material and provided with an outermost insulator layer on an outermost side in a thickness direction; a coil conductor provided in the base and including a circumferential portion and a lead portion at least partially penetrating through the outermost insulator layer; an external terminal provided on a surface of the outermost insulator layer and connected to the circumferential portion through the lead portion; and a first conductor pattern provided on the surface of the outermost insulator layer opposite to the external terminal and connected to the external terminal through a through hole penetrating through the outermost insulator layer and provided separately from the lead portion.

### BRIEF DESCRIPTION OF THE DRAWINGS

FIG. 1 is a perspective view of a coil component according to a first embodiment;

FIG. 2 is an exploded perspective view of the coil component according to the first embodiment;

FIG. 3 is a cross-sectional view of the coil component according to the first embodiment;

FIG. 4 is a plan view of an insulator layer according to the first embodiment;

FIG. 5 is a plan view of the insulator layer according to the first embodiment;

FIG. 6 is a plan view of the insulator layer according to the first embodiment;

FIG. 7 is a flowchart showing a manufacturing method according to the first embodiment;

FIG. 8 is a cross-sectional view of a coil component according to a comparative embodiment;

FIG. 9 is a plan view of an insulator layer according to the comparative embodiment;

FIG. 10 is a diagram illustrating lines of force in a simulation;

FIG. 11 is a cross-sectional view of a coil component according to a second embodiment;

FIG. 12 is a plan view of an insulator layer according to the second embodiment;

FIG. 13 is a cross-sectional view of a coil component according to a third embodiment; and

FIG. 14 is a plan view of an insulator layer according to the third embodiment.

### DESCRIPTION OF THE PREFERRED EMBODIMENTS

As in International Publication No. WO2009/096243, by providing a groove on the mounting surface of the substrate, the adhesion strength of the external terminal can be enhanced. However, this is not sufficient for the stress applied to the external terminal in the direction perpendicular to the mounting surface.

An object of the present disclosure is to provide a coil component capable of enhancing the adhesion of an external terminal.

Embodiments of the present disclosure will be described in detail in the following, but the present disclosure is not limited thereto. In the present specification and the drawings, components having substantially the same functional configuration may be denoted by the same reference numerals, thereby omitting redundant description.

### First embodiment

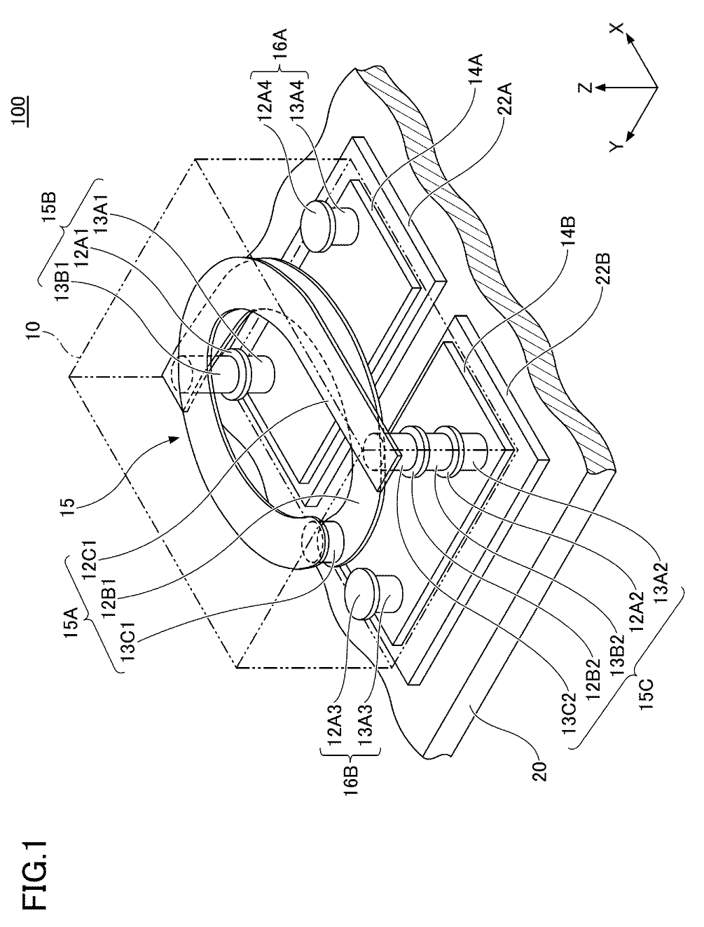

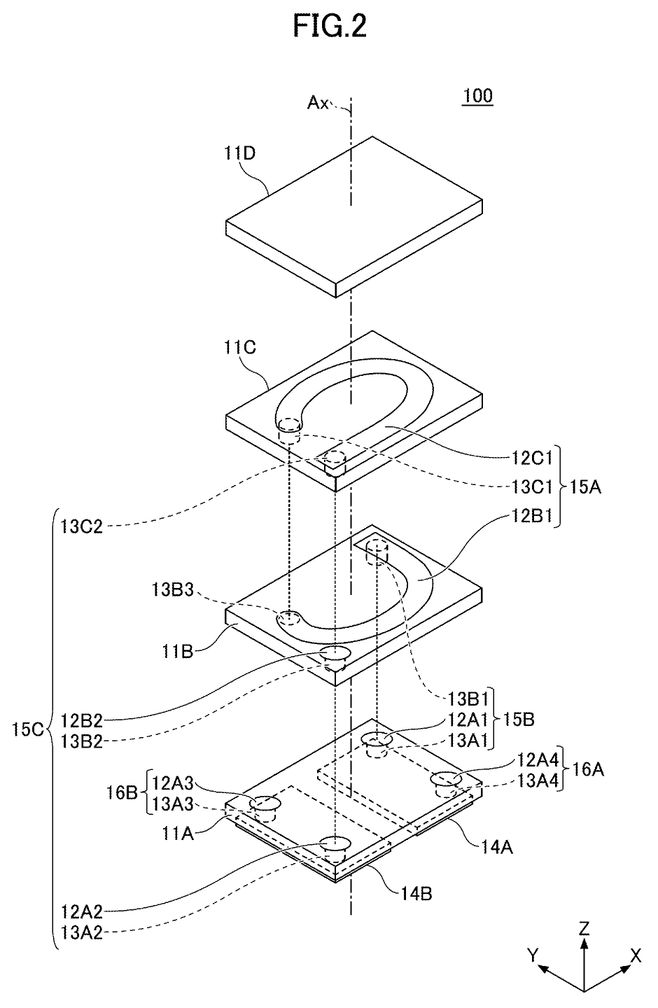

FIG. 1 is a perspective view of a coil component according to a first embodiment. FIG. 2 is an exploded perspective view of the coil component according to the first embodiment. The thickness direction of insulator layers 11A to 11D is a Z-direction, the arrangement direction of the external terminals 14A and 14B is an X-direction, and the direction orthogonal to the X- and Z-directions is a Y-direction.

As shown in FIGS. 1 and 2, a coil component 100 includes a base 10, a coil conductor 15, and external terminals 14A and 14B. The base 10 includes a plurality of insulator layers 11A to 11D stacked in the Z-direction, and is a substantially rectangular parallelepiped. The coil conductor 15 is provided in the base 10, and includes a circumferential portion 15A and lead portions 15B and 15C. The circumferential portion 15A forms an inductor, and the lead portions 15B and 15C connect both ends of the circumferential portion 15A to the external terminals 14A and 14B, respectively. The external terminals 14A and 14B are provided on the lower surface (-Z plane) of the base 10. The coil component 100 is mounted on a mounting substrate 20. Lands 22A and 22B are provided on the upper surface (+Z plane) of the mounting substrate 20. The external terminals 14A and 14B are joined to the lands 22A and 22B, respectively, by a joining member such as solder.

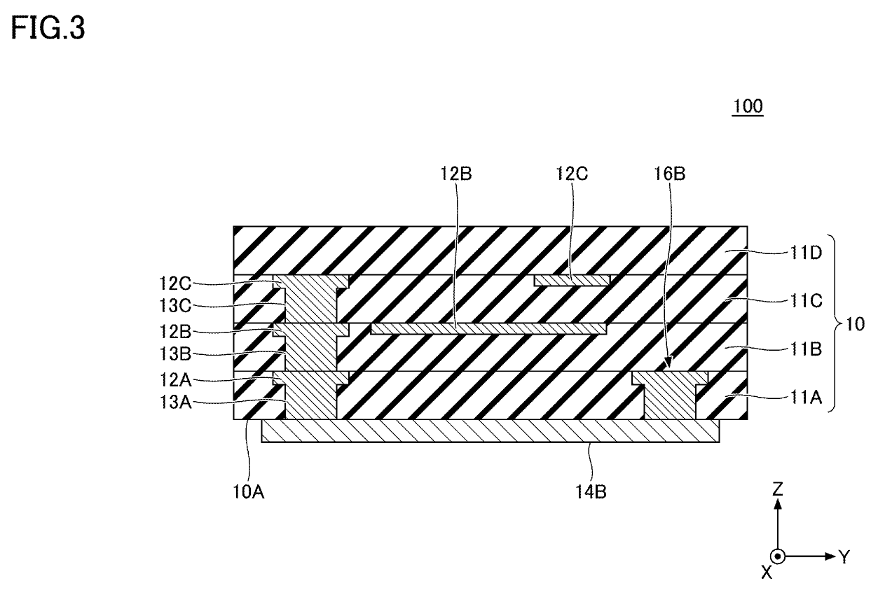

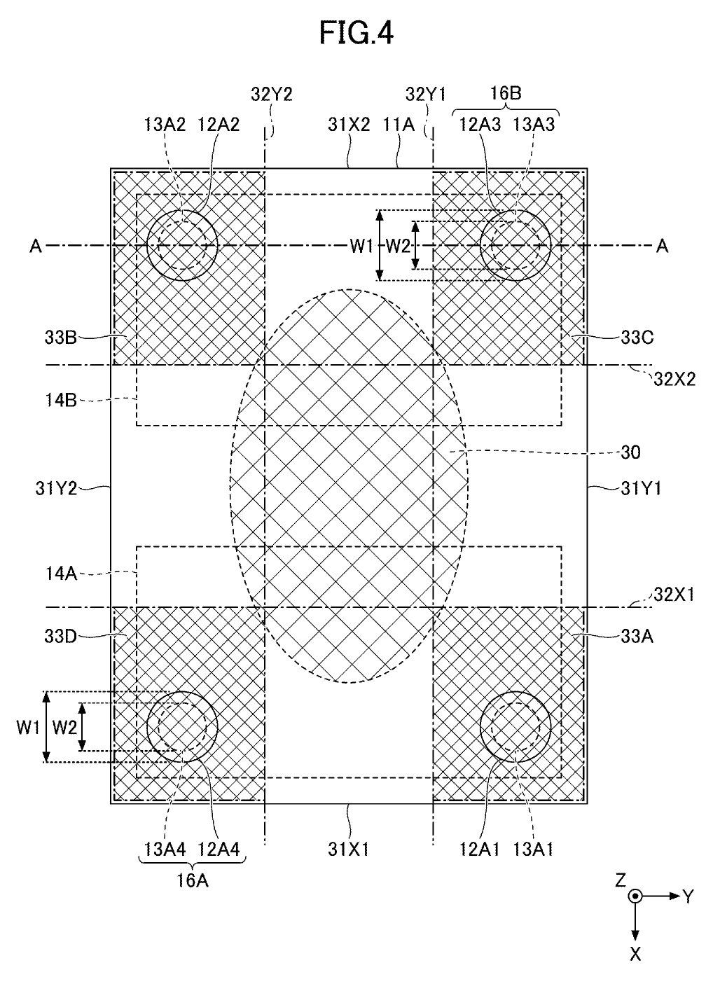

FIG. 3 is a cross-sectional view of the coil component according to the first embodiment. FIGS. 4-6 are plan views of an insulator layer according to the first embodiment. FIG. 3 corresponds to a cross section taken along a line A-A of FIGS. 4-6.

As shown in FIG. 3, the base 10 includes insulator layers 11A to 11D and conductor layers 12A to 12C. The insulator layers 11A to 11D are stacked in the Z-direction. The conductor layers 12A to 12C are stacked alternately with the insulator layers 11A to 11D. Through holes 13A to 13C penetrate through the insulator layers 11A to 11C. The conductor layers 12A to 12C are embedded in the through holes 13A to 13C. The lower surface (-Z plane) of the insulator layer 11A is a mounting surface 10A. The external terminals 14A and 14B are provided on the mounting surface 10A. Although the four insulator layers 11A to 11D will be described as an example, the number of insulator layers can be arbitrarily set to 2, 3, 5 or more.

As shown in FIG. 4, conductor patterns 12A1 to 12A4 are provided on the upper surface (+Z plane) of the insulator layer 11A and are formed by the conductor layer 12A of FIG. 3. The external terminals 14A and 14B are provided on the lower surface (-Z plane) of the insulator layer 11A. Through holes 13A1 to 13A4 are the through hole 13A of FIG. 3. The conductor patterns 12A1 and 12A4 are electrically connected to the external terminal 14A through the through holes 13A1 and 13A4, respectively. The conductor patterns 12A2 and 12A3 are electrically connected to the external terminal 14B via the through holes 13A2 and 13A3, respectively. A wedge 16B includes the conductor pattern 12A3 and the through hole 13A3. A wedge 16A includes the conductor pattern 12A4 and the through hole 13A4. A width W1 of the conductor patterns 12A3 and 12A4 is larger than a width W2 of the through holes 13A3 and 13A4.

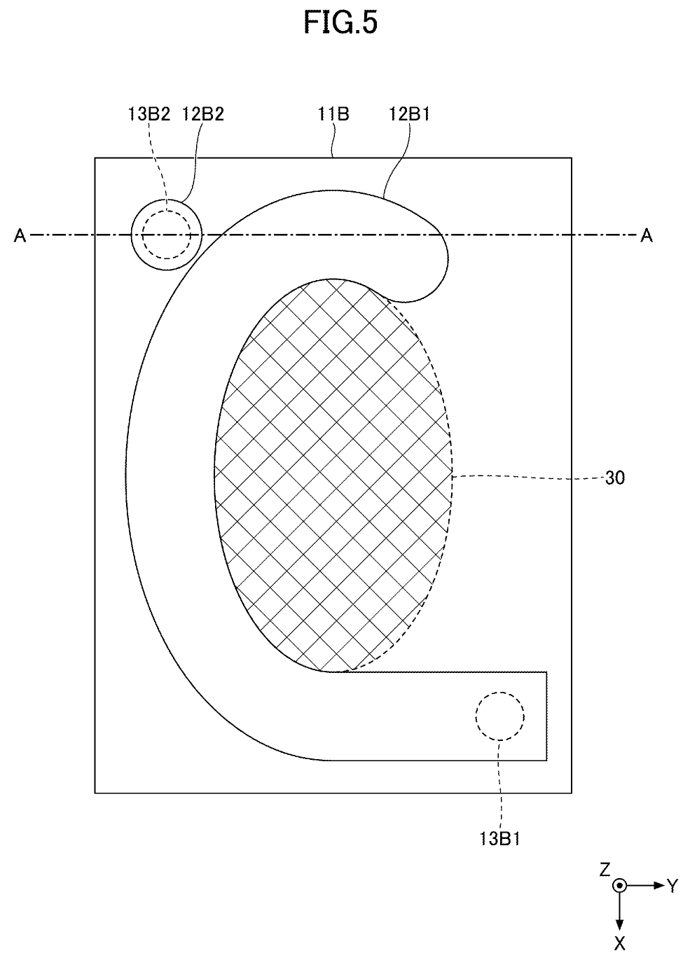

As shown in FIG. 5, conductor patterns 12B1 and 12B2 are provided on the upper surface (+Z plane) of the insulator layer 11B and are formed by the conductor layer 12B. Through holes 13B1 and 13B2 are the through holes 13B of FIG. 3. The conductor pattern 12B1 is linear. One end of the conductor pattern 12B1 is electrically connected to the conductor pattern 12A1 of FIG. 4 through the through hole 13B1. The conductor pattern 12B2 is electrically connected to the conductor pattern 12A2 of FIG. 4 through the through hole 13B2.

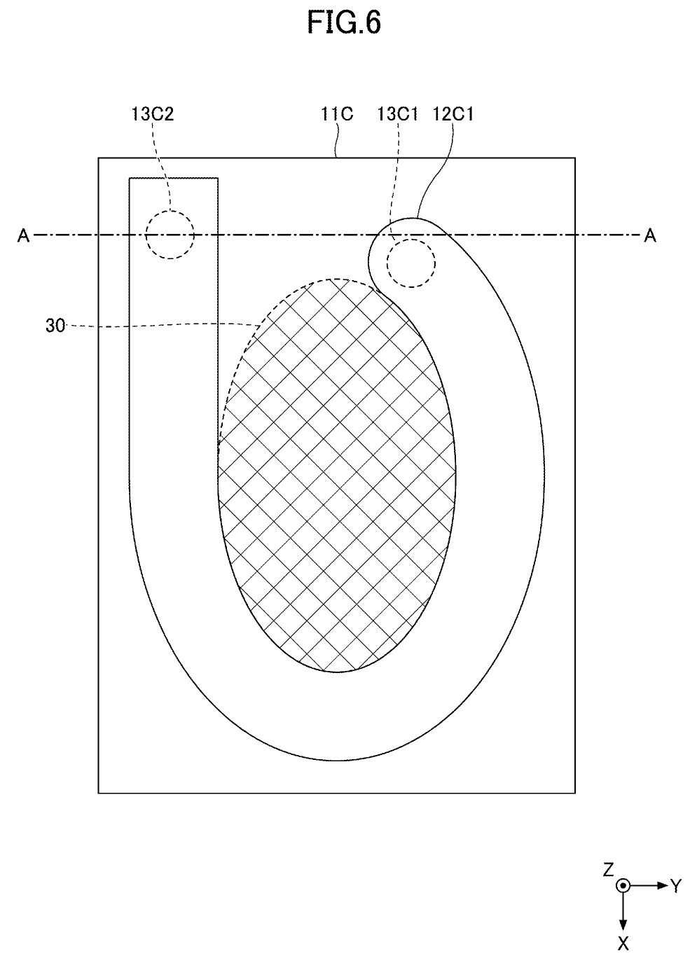

As shown in FIG. 6, a conductor pattern 12C1 is provided on the upper surface (+Z plane) of the insulator layer 11C and is formed of the conductor layer 12C. The through holes 13C1 and 13C2 are the through hole 13C of FIG. 3. The conductor pattern 12C1 is linear. One end of the conductor pattern 12C1 is electrically connected to the other end of the conductor pattern 12B1 of FIG. 5 through a through hole 13C1. The other end of the conductor pattern 12C1 is electrically connected to the conductor pattern 12B2 of FIG. 5 through the through hole 13C2.

As shown in FIGS. 1 and 2, the circumferential portion 15A of the coil conductor 15 includes the conductor patterns 12B1 and 12C1 and the through hole 13C1. The number of turns of the circumferential portion 15A is about 1.5. The number of turns of the circumferential portion 15A may be less than 1 or greater than 1 and can be arbitrarily set. The lead portion 15B of the coil conductor 15 includes the conductor pattern 12A1 and through holes 13A1 and 13B1. The lead portion 15C of the coil conductor 15 includes the conductor patterns 12A2 and 12B2 and through holes 13A2, 13B2, and 13C2.

In FIGS. 4-6, a region occupying a space inward of conductor patterns 12B1 and 12C1 as seen in the Z-direction is a region 30. Although the plan shape of the region 30 is described by taking an elliptical shape as an example, the plan shape of the region 30 can be arbitrarily set such as a circular shape, a rectangular shape, or a polygonal shape.

In the first embodiment, the length dimension of the coil component 100 in the X-direction is, for example, 0.2 mm to 6.0 mm. The width dimension of the coil component 100 in the Y-direction is, for example, 0.1 mm to 4.5 mm. The height dimension of the coil component 100 in the Z-direction is, for example, 0.1 mm to 4.0 mm. The dimension of the coil component 100 can be arbitrarily set.

The insulator layers 11A to 11D include, for example, a magnetic material. As the magnetic material of the insulator layers 11A to 11D, a soft magnetic alloy material, a composite magnetic material in which magnetic particles are dispersed in a resin, a ferrite material, or any other known magnetic material may be used.

Metal magnetic particles included in the magnetic material of the insulator layers 11A to 11D include, for example, at least one of magnetic metals such as iron (Fe), nickel (Ni), or cobalt (Co). The metal magnetic particles may be, for example, an Fe-Ni alloy, an Fe-Co alloy, an Fe-Si alloy, an Fe-Si-Al alloy, an Fe-Si-Cr alloy, an Fe-Si-Al-Cr alloy, or an Fe-Si-Cr-B alloy. In addition to the above, the metal magnetic particles may contain at least one element of manganese (Mn), zinc (Zn), phosphorus (P), copper (Cu), neodymium (Nd), titanium (Ti), vanadium (V), tantalum (Ta), or tungsten (W).

The conductor layers 12A to 12C mainly include, for example, a metal such as copper (Cu), gold (Au), silver (Ag), nickel (Ni), or alloys of two or more of these metals. The external terminals 14A and 14B mainly include, for example, a metal such as copper, silver, palladium (Pd), nickel, or alloys of two or more of these metals.

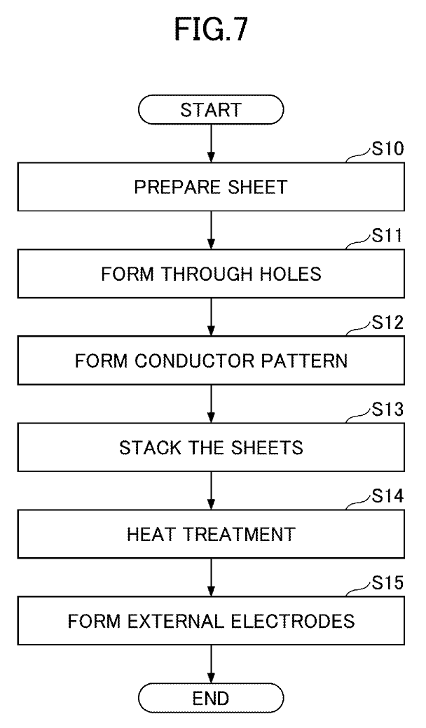

FIG. 7 is a flowchart showing a manufacturing method according to the first embodiment. As shown in FIG. 7, a sheet is prepared (step S10). In step S10, the sheet is formed from, for example, a magnetic material paste containing metal magnetic particles, a binder resin, and a solvent. Then, through holes are formed in the sheet (step S11). In step S11, through holes penetrating through the sheet are formed by, for example, irradiating the sheet with a laser beam. No through holes are formed in the sheet for the insulator layer 11D.

Then, a conductor pattern is formed on the sheet (step S12). In step S12, a conductive paste containing metal powder such as copper powder, a binder resin, and a solvent is applied on the sheet. The through holes are embedded by the conductive paste. The conductive paste is formed, for example, by screen printing. The conductive paste to be the conductor layers 12A to 12C is formed on the lower surface (-Z surface) of the insulator layers 11B to 11D. The conductive paste to be a partial layer in each of the external terminals 14A and 14B is formed on the lower surface (-Z surface) of the insulator layer 11A.

Next, the sheets on which the conductive patterns are formed are stacked together (step S13). In step S13, the sheets for the insulator layers 11A to 11D are stacked together. Next, the stacked sheets are subjected to a heat treatment (step S14). In step S14, the magnetic material sheets and the conductive paste are subjected to firing treatment to form a stacked body including the insulator layers 11A to 11D, the conductor layers 12A to 12C, and the partial layers of the external terminals 14A and 14B.

Next, the external terminals 14A and 14B are formed on the mounting surface 10A of the base 10 (step S15). In step S15, another conductor layer is formed on the conductor layer which is the partial layer in each of the external terminals 14A and 14B formed on the mounting surface 10A by, for example, plating. Thus, the external terminals 14A and 14B are formed.

### Comparative embodiment

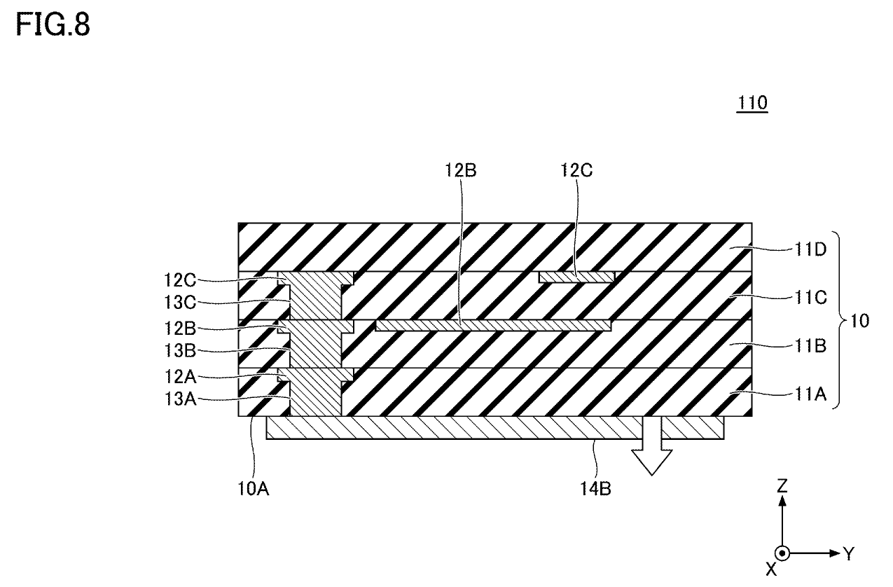

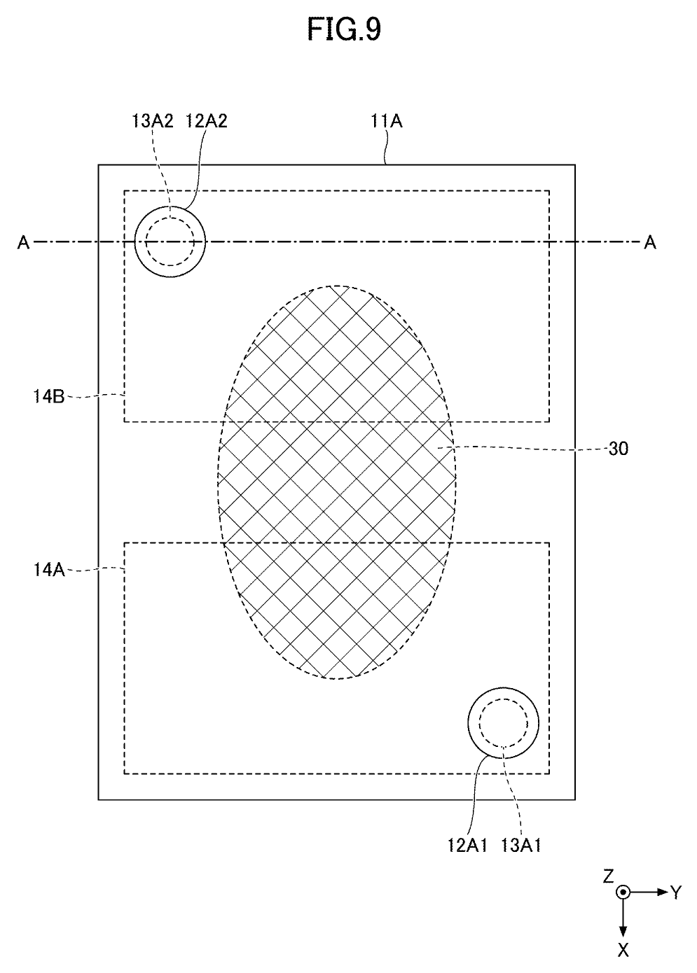

FIG. 8 is a cross-sectional view of the coil component according to a comparative embodiment. FIG. 9 is a plan view of the insulator layer according to the comparative embodiment. As shown in FIGS. 8 and 9, in a coil component 110 of the comparative embodiment, the wedges 16A and 16B are not provided. Therefore, the adhesion between the external terminal 14B and the base 10 is low. For example, when the external terminal 14B is applied in the -Z-direction as indicated by an arrow, the external terminal 14B may be peeled off from the base 10. For example, when a drop test is performed with the coil component 110 mounted on the mounting substrate 20, the external terminal 14B is peeled off from the base 10. When the external terminals 14A and 14B are provided only on the mounting surface 10A of the surface of the base 10 like the coil component 100, the external terminals 14A and 14B are easily peeled off from the base 10.

Furthermore, when a groove is provided perpendicular to the mounting surface 10A and the external terminals 14A and 14B are inserted into the groove as shown in FIG. 1 of International Publication No. WO2009/096243, the external terminals 14A and 14B are easily peeled off when a force perpendicular to the mounting surface 10A as shown in FIG. 8 is applied to the external terminals 14A and 14B.

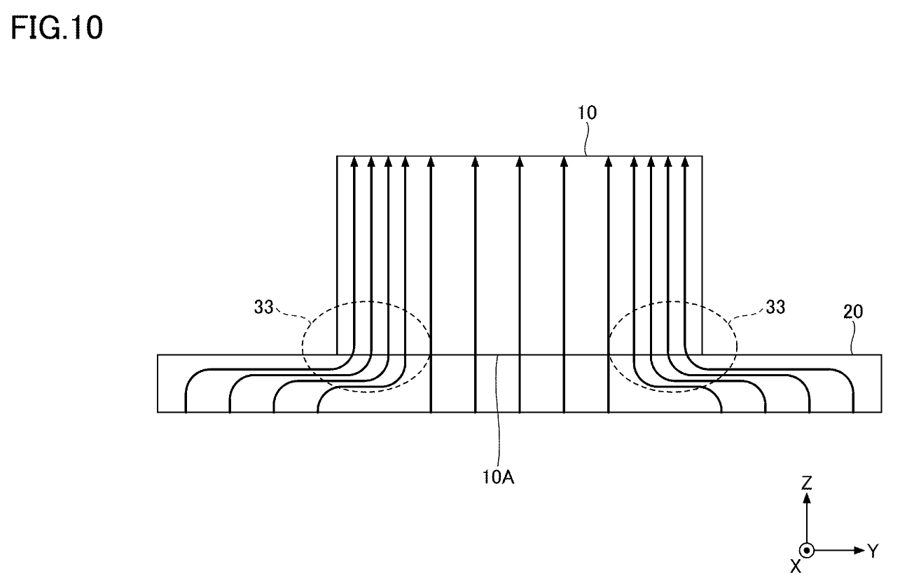

FIG. 10 is a diagram illustrating lines of force in a simulation. The lines of force in the base 10 and the mounting substrate 20 when a force is applied to the mounting substrate 20 from the lower surface (-Z surface) are shown. As shown in FIG. 10, the stress is concentrated on a corner portion 33 of the mounting surface 10A of the base 10.

### Description of first embodiment

According to the first embodiment, the conductor patterns 12A3 and 12A4 (first conductor patterns) are provided on the upper surface (the surface opposite to the external terminals 14A and 14B in the insulator layer 11A) of the outermost insulator layer 11A (outermost insulator layer) in the Z-direction. The conductor patterns 12A3 and 12A4 are connected to the external terminals 14A and 14B through the through holes 13A3 and 13A4, respectively, which penetrate the insulator layer 11A. The through holes 13A3 and 13A4 are provided separately from at least a part of the lead portions 15B and 15C. Thus, the wedge 16B is formed from the conductor pattern 12A3 and the through hole 13A3, and the wedge 16A is formed from the conductor pattern 12A4 and the through hole 13A4. Therefore, even when a force is applied to the external terminals 14A and 14B as shown by the arrow in FIG. 8, the external terminals 14A and 14B can be prevented from peeling off from the base 10.

The planar shapes of the through holes 13A3 and 13A4 can be appropriately designed to be elliptical, polygonal, or linear, in addition to circular. The planar shapes of the conductor patterns 12A3 and 12A4 can be appropriately designed such as elliptical, polygonal, and linear shapes in addition to circular shapes. The planar shapes of the conductor patterns 12A3 and 12A4 may be similar to the planar shapes of the through holes 13A3 and 13A4, or may not be similar.

As shown in FIG. 4, the width W1 of the conductor patterns 12A3 and 12A4 is larger than the width W2 of the through holes 13A3 and 13A4 when viewed in the Z-direction. This reduces the possibility of the conductor patterns 12A3 and 12A4 being pulled out from the through holes 13A3 and 13A4, respectively, even when a force is applied to the external terminals 14A and 14B in the -Z-direction. Therefore, it is possible to suppress the external terminals 14A and 14B from peeling off from the base 10. The width W1 is preferably 1.5 times or more of the width W2, and more preferably 2 times or more. From the viewpoint of suppressing loss such as eddy current loss, the width W1 is preferably 3 times or less of the width W2. It is preferable that the conductor patterns 12A3 and 12A4 are provided in all the regions surrounding the through holes 13A3 and 13A4 as seen in the Z-direction.

The region 30 surrounded by the circumferential portion 15A has a high magnetic flux density as seen in the Z-direction. Therefore, when the wedges 16A and 16B are provided in the region 30, the eddy current loss or the like increases and the loss increases. Therefore, it is preferable that at least one of the conductor patterns 12A3 or 12A4 is provided outside the region 30, and it is more preferable that all of the conductor patterns 12A3 and 12A4 are provided outside the region 30.

As shown in FIG. 10, stress concentrates on the corner portion 33 of the base 10. Therefore, as shown in FIG. 4, the conductor patterns 12A3 and 12A4 are provided at the corner portions 33C and 33D (first corner portions) of the base 10, respectively, when viewed from the Z-direction. Thus, the peeling of the external terminals 14A and 14B can be suppressed at the corner portions 33C and 33D where the stress applied to the external terminals 14A and 14B is large and the external terminals 14A and 14B are easily peeled off.

The lead portions 15B and 15C are provided at the corner portions 33A and 33B (second corner portions) different from the corner portions 33C and 33D of the base 10, when viewed from the Z-direction. The lead portions 15B and 15C include the conductor patterns 12A1 and 12A2 in the base 10. Therefore, the external terminals 14A and 14B are difficult to be peeled off from the base 10 at the portions where the lead portions 15B and 15C are connected to the external terminals 14A and 14B, respectively. Therefore, by connecting the lead portions 15B and 15C to the corner portions 33A and 33B and providing the wedges 16A and 16B to the corner portions 33C and 33D, the peeling off of the external terminals 14A and 14B from the base 10 can be suppressed.

The corner portion of the base 10 will be described with reference to FIG. 4. The planar shape of the base 10 is substantially rectangular. The base 10 includes sides 31X1 and 31X2 facing each other in the X-direction and sides 31Y1 and 31Y2 facing each other in the Y-direction. Imaginary straight lines dividing the base 10 into three equal parts between the sides 31X1 and 31X2 in the X-direction are defined as imaginary straight lines 32X1 and 32X2, and imaginary straight lines dividing the base 10 into three equal parts between the sides 31Y1 and 31Y2 in the Y-direction are defined as imaginary straight lines 32Y1 and 32Y2. In this case, a portion surrounded by the sides 31X1 and 31Y1 and the imaginary straight lines 32X1 and 32Y1 is referred to as a corner portion 33A. A portion surrounded by the sides 31X2 and 31Y2 and the imaginary straight lines 32X2 and 32Y2 is referred to as a corner portion 33B, a portion surrounded by the sides 31X2 and 31Y1 and the imaginary straight lines 32X2 and 32Y1 is referred to as a corner portion 33C, and a portion surrounded by the sides 31X1 and 31Y2 and the imaginary straight lines 32X1 and 32Y2 is referred to as a corner portion 33D.

The external terminals 14A and 14B are provided only on the mounting surface 10A of the insulator layer 11A in the surface of the base 10. In this case, when stress concentrates on the corner portion 33 of the base 10, the external terminals 14A and 14B are apt to be peeled off. Therefore, it is preferable to provide the wedges 16A and 16B. The external terminals 14A and 14B may be provided from the mounting surface 10A of the base 10 to a surface other than the mounting surface 10A.

The coil conductor 15 includes the conductor patterns 12B1 and 12C1 (second conductor patterns) included in at least one of the plurality of conductor layers 12A to 12C. The wedges 16A and 16B include the conductor patterns 12A3 and 12A4 included in the conductor layer 12A. In the base 10 in which the plurality of insulator layers 11A to 11D and the plurality of conductor layers 12A to 12C are alternately stacked in the Z-direction, the wedges 16A and 16B are formed by using the conductor layer 12A. Thus, the wedges 16A and 16B can be formed without increasing the manufacturing labor hours.

### Second embodiment

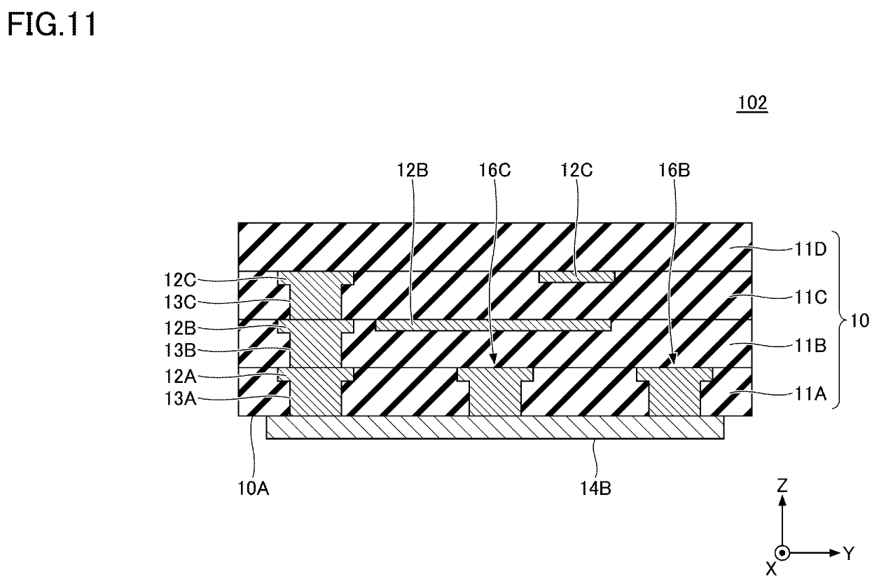

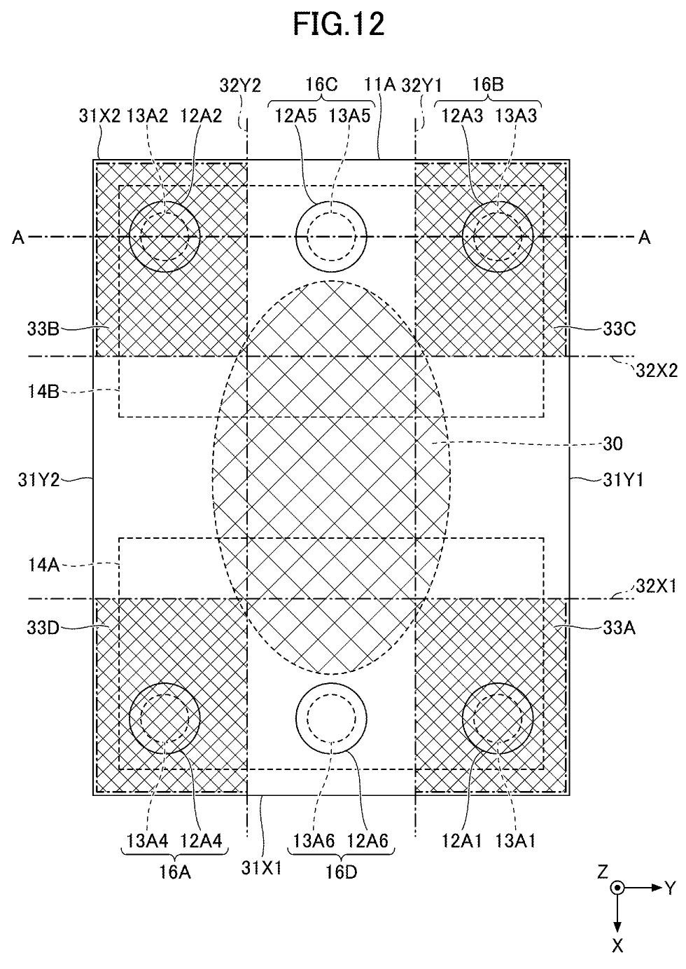

FIG. 11 is a cross-sectional view of a coil component according to a second embodiment. FIG. 12 is a plan view of an insulator layer according to the second embodiment. FIG. 11 corresponds to a cross section taken along the line A-A of FIG. 12, and FIG. 12 is a plan view of the insulator layer 11A.

As shown in FIGS. 11 and 12, a coil component 102 of the second embodiment includes wedges 16C and 16D in addition to the wedges 16A and 16B. The conductor layer 12B includes conductor patterns 12A5 and 12A6 in addition to the conductor patterns 12A1 to 12A4. In the insulator layer 11A, through holes 13A5 and 13A6 are formed in addition to the through holes 13A1 to 13A4. The wedge 16C includes the conductor pattern 12A5 and the through hole 13A5. The wedge 16D includes the conductor pattern 12A6 and the through hole 13A6. Other configurations are the same as those of the first embodiment, and description thereof is omitted.

In the second embodiment, a plurality of conductor patterns 12A3 and 12A5 are provided for one external terminal 14B. A plurality of the conductor patterns 12A4 and 12A6 are provided for one external terminal 14A. Thus, peeling of the external terminals 14A and 14B can be suppressed. The number of wedges provided for one external terminal 14A or 14B may be three or more.

The wedge 16C is provided between the corner portions 33B and 33C, and the wedge 16D is provided between the corner portions 33A and 33D. Thus, the lead portion 15C, the wedges 16B and 16C are provided at the corner portion 33B, the corner portion 33C, and the portion between the corner portions 33B and 33C, respectively. The wedges 16B and 16C and the lead portion 15B are provided at the corner portion 33A, the corner portion 33D, and the portion between the corner portions 33A and 33D, respectively. Therefore, the wedges or the lead portions are formed in all the portions where the external terminals 14A and 14B are divided into 3 portions, respectively, such that peeling of the external terminals 14A and 14B can be further suppressed.

### Third embodiment

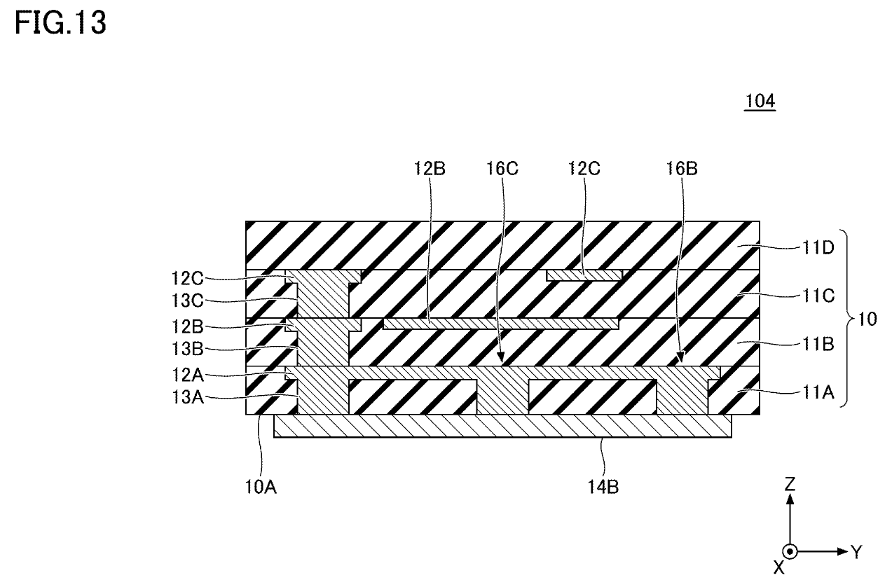

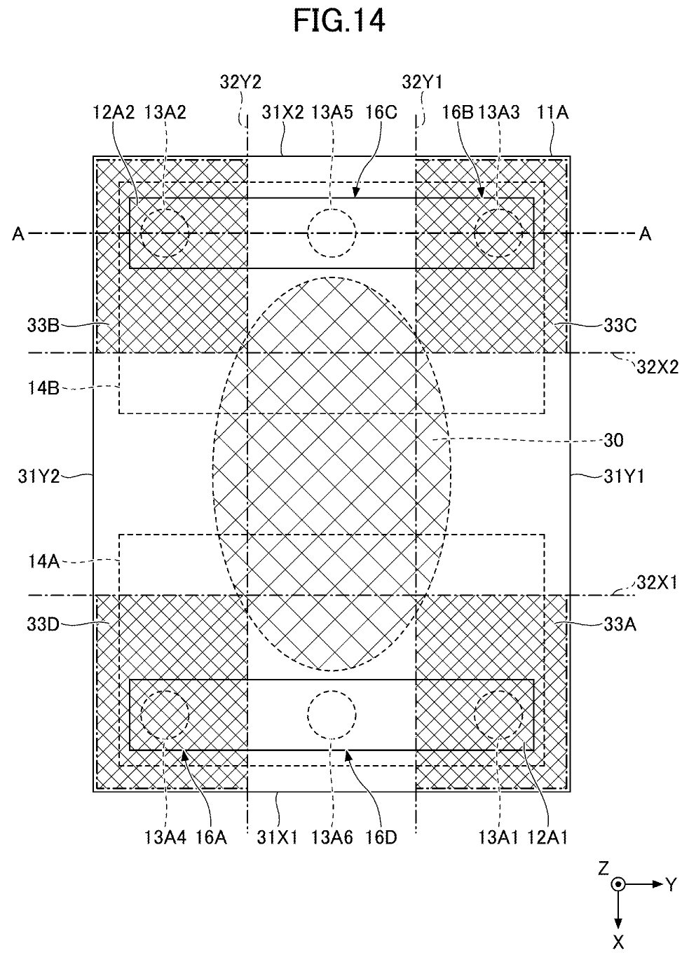

FIG. 13 is a cross-sectional view of a coil component according to a third embodiment. FIG. 14 is a plan view of an insulator layer according to the third embodiment. FIG. 13 corresponds to a cross section taken along the line A-A of FIG. 14, and FIG. 14 is a plan view of the insulator layer 11A.

As shown in FIGS. 13 and 14, in a coil component 104 according to the third embodiment, one conductor pattern 12A1 is connected to the external terminal 14A through a plurality of through holes 13A1, 13A4, and 13A6. One conductor pattern 12A2 is connected to the external terminal 14B through a plurality of through holes 13A2, 13A3, and 13A5. In this manner, the wedges 16A and 16D and the lead portion 15B share the conductor pattern 12A1, and the wedges 16B and 16C and the lead portion 15C share the conductor pattern 12A2. Thus, even when a force is applied to the external terminals 14A and 14B in the -Z-direction, the possibility of the conductor patterns 12A1 and 12A2 being pulled out from the through holes 13A1 to 13A6 is reduced. Therefore, the external terminals 14A and 14B can be prevented from peeling off from the base 10. Other configurations are the same as those of the first embodiment, and description thereof is omitted.

As in the second and third embodiments, when the area of the conductor pattern of the wedge increases, the loss such as eddy current loss increases. The area of the conductor pattern can be designed in consideration of the adhesion and characteristics of the external terminals 14A and 14B.

According to the present disclosure, it is possible to provide a coil component capable of enhancing the adhesion of the external terminal.

Although the embodiments have been described in detail above, the present disclosure is not limited to specific embodiments, and various modifications and changes are possible within the scope described in the appended claims.

The embodiments of the present disclosure are, for example, as follows.

### 1

A coil component including:
a base including a magnetic material and provided with an outermost insulator layer on an outermost side in a thickness direction;
a coil conductor provided in the base and including a circumferential portion and a lead portion at least partially penetrating through the outermost insulator layer;
an external terminal provided on a surface of the outermost insulator layer and connected to the circumferential portion through the lead portion; and
a first conductor pattern provided on the surface of the outermost insulator layer opposite to the external terminal and connected to the external terminal through a through hole penetrating through the outermost insulator layer and provided separately from the lead portion.

### 2

The coil component according to <1>, wherein
a width of the first conductor pattern is larger than a width of the through hole when viewed in the thickness direction.

### 3

The coil component according to <1> or <2>, wherein
at least one of the first conductor patterns, each of the first conductor patterns being the first conductor pattern, is provided outside a region surrounded by the coil conductor when viewed in the thickness direction.

### 4

The coil component according to any one of <1> to <3>, wherein
all of the first conductor patterns, each of the first conductor patterns being the first conductor pattern, are provided outside a region surrounded by the coil conductor when viewed in the thickness direction.

### 5

The coil component according to any one of <1> to <4>, wherein
the first conductor pattern is provided at a first corner portion of the base when viewed in the thickness direction.

### 6

The coil component according to <5>, wherein
the lead portion is provided at a second corner portion of the base different from the first corner portion when viewed in the thickness direction.

### 7

The coil component according to any one of <1> to <6>, wherein
a plurality of the first conductor patterns are provided for one external terminal.

### 8

The coil component according to any one of <1> to <7>, wherein
one of the first conductor patterns is connected to the external terminal via a plurality of through holes, each of the through holes being the through hole.

### 9

The coil component according to any one of <1> to <8>, wherein
the external terminal is provided only on the surface of the outermost insulator layer among surfaces of the base.

### 10

The coil component according to any one of <1> to <9>, wherein
the base includes:
   a plurality of insulator layers including the outermost insulator layer and stacked in the thickness direction; and
   a plurality of conductor layers including the first conductor pattern and alternately stacked with the plurality of insulator layers, wherein
the coil conductor includes a second conductor pattern included at least in one conductor layer of the plurality of the conductor layers.

What is claimed is:

1. A coil component, comprising:
a base including a magnetic material and provided with an outermost insulator layer on an outermost side in a thickness direction;
a coil conductor provided in the base and including a circumferential portion and a lead portion at least partially penetrating through the outermost insulator layer;
an external terminal provided on a surface of the outermost insulator layer and connected to the circumferential portion through the lead portion; and
a first conductor pattern provided on the surface of the outermost insulator layer opposite to the external terminal and connected to the external terminal through a through hole penetrating through the outermost insulator layer and provided separately from the lead portion.

2. The coil component according to claim 1, wherein
a width of the first conductor pattern is larger than a width of the through hole when viewed in the thickness direction.

3. The coil component according to claim 1, wherein
at least one of the first conductor patterns, each of the first conductor patterns being the first conductor pattern, is provided outside a region surrounded by the coil conductor when viewed in the thickness direction.

4. The coil component according to claim 1, wherein
all of the first conductor patterns, each of the first conductor patterns being the first conductor pattern, are provided outside a region surrounded by the coil conductor when viewed in the thickness direction.

5. The coil component according to claim 1, wherein
the first conductor pattern is provided at a first corner portion of the base when viewed in the thickness direction.

6. The coil component according to claim 5, wherein
the lead portion is provided at a second corner portion of the base different from the first corner portion when viewed in the thickness direction.

7. The coil component according to claim 1, wherein
a plurality of first conductor patterns, each of the first conductor patterns being the first conductor pattern, are provided for one external terminal.

8. The coil component according to claim 1, wherein
one of first conductor patterns, each of the first conductor patterns being the first conductor pattern, is connected to the external terminal via a plurality of through holes, each of the through holes being the through hole.

9. The coil component according to claim 1, wherein
the external terminal is provided only on the surface of the outermost insulator layer among surfaces of the base.

10. The coil component according to claim 1, wherein
the base includes:
a plurality of insulator layers including the outermost insulator layer and stacked in the thickness direction; and
a plurality of conductor layers including the first conductor pattern and alternately stacked with the plurality of insulator layers, wherein
the coil conductor includes a second conductor pattern included at least in one conductor layer of the plurality of the conductor layers.
